(19) United States
(12) Patent Application Publication
(10) Pub. No.: US 2007/0293146 A1
(43) Pub. Date: Dec. 20, 2007

(54) SATELLITE NAVIGATION CONVERSTION DEVICE

(75) Inventors: I-Jen Lai, Taipei City (TW); Nils Wallnas, Taipei City (TW)

Correspondence Address: C. S. CONSULTANT CO., P.O. BOX 108-00403, TAIPEI 106, omitted

(73) Assignee: C.S. CONSULTANT CO, Taipei City (TW)

(21) Appl. No.: 11/423,954

(22) Filed: Jun. 14, 2006

(51) Int. Cl. H04H 7/00; H04Q 7/20

(52) U.S. Cl. 455/3.06; 455/456.1

(57) ABSTRACT

A satellite navigation conversion device having a portable player is disclosed. The satellite navigation conversion device comprises a microprocessor for controlling and processing signals of a external module in the satellite navigation conversion device, a satellite navigation module for receiving and transmitting position signals, a wired transmission interface for receiving/storing data from/to the portable player, a power control module for converting power supply into direct current suitable for the satellite navigation conversion device and the portable player, and a power input device for transmitting power supply between the satellite navigation conversion device and a external power devices.

### BACKGROUND OF THE INVENTION

1. Field of the Invention

The present invention relates to a satellite navigation conversion device, and more particularly to a satellite navigation conversion device comprising a power control module to convert power supply into direct current suitable for the satellite navigation conversion device and a portable player, wherein a buckling portion of the satellite navigation conversion device can connect the portable player to the satellite navigation conversion device.

2. Description of the Related Art

The GPS (Global Position System) has become a familiar term to people in recent years, and the use of GPS has extended from the military at the earlier stage to the public use. Nowadays, GPS has greater demand in business, shipping and traveling fields.

The application of the GPS in car is known to guide the driver to the destination. Conventional satellite navigation is comprised of a single satellite navigation system and is expensive, or comprises a portable player, such as a cellular phone or a PDA, which has multiple functions with a transceiver.

Referring to FIG. 4, the conventional satellite navigation system comprises a PDA A and a plug-in positioning signal transceiver B. When in use, the plug-in positioning signal transceiver B must be plugged into the PDA A. The plug-in positioning signal transceiver B uses power supplied by the PDA A in order to interact with the GPS and transmit position signals to the PDA A. The PDA A combines a map stored therein with the position signals to calculate the route from the present position to a destination and the result is displayed on a screen of the PDA A for reference. However, there is no independent power supply in the plug-in positioning signal transceiver B, and the PDA A and plug-in positioning signal transceiver B using the same power supply may be insufficient. Besides, the conventional satellite navigation system must be properly secured to the car by using a securing device. Thus, the cost of the satellite navigation system is substantially high.

Referring to FIG. 5, another conventional satellite navigation system is described as follows. The conventional satellite navigation system comprises a PDA A and a wireless positioning signal transceiver C. When in use, the PDA A need not be connected to the wireless positioning signal transceiver C. The wireless positioning signal transceiver C interacts with the GPS to receive position signals from the GPS and transmits the position signals to the PDA A via a Bluetooth for storing. The PDA A combines a map stored therein with the position signals to calculate the route from the present position to a destination and the result is displayed on a screen of the PDA A for reference. Although the wireless positioning signal transceiver C has an independent power supply, but when the power supply of both the PDA A and the wireless positioning signal transceiver C are exhausted at the same time, two separate chargers are required for charging. Besides, the satellite navigation system must be properly secured to the car by using a securing device. Thus, the cost of the satellite navigation system is substantially high.

Therefore, how to overcome the above defects of the conventional satellite navigation system is an important issue for the manufacturer in the field.

### SUMMARY OF THE INVENTION

According to an aspect of the present invention, the satellite navigation conversion device and the portable player share the same power input device. Thus, the user need not worry that the power supply of the portable player and the satellite navigation conversion device exhaust at the same time, and the user need not charge the portable player and the satellite navigation conversion device separately.

According to another aspect of the present invention, the satellite navigation conversion device comprises a buckling portion for connecting the portable player to the satellite navigation conversion device. Thus, an additional securing element for securing the satellite navigation conversion device or the portable player in the car may be eliminated. Therefore, the cost can be substantially reduced.

### BRIEF DESCRIPTION OF THE DRAWING

FIG. 1 is a block diagram of a satellite navigation conversion device according to an embodiment of the present invention.

FIG. 2 is an elevational view of the satellite navigation conversion device according to an embodiment of the present invention.

FIG. 3 is an elevational view of the satellite navigation conversion device according to another embodiment of the present invention.

FIG. 4 is an elevational view of a prior art.

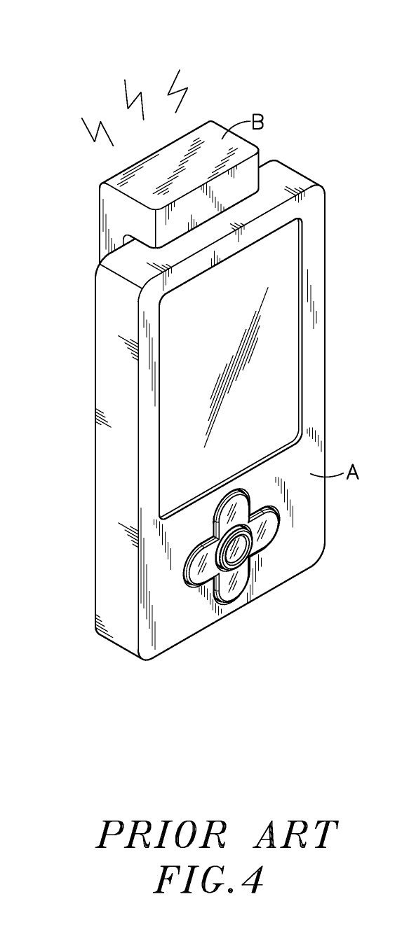

FIG. 5 is an elevational view of another prior art.

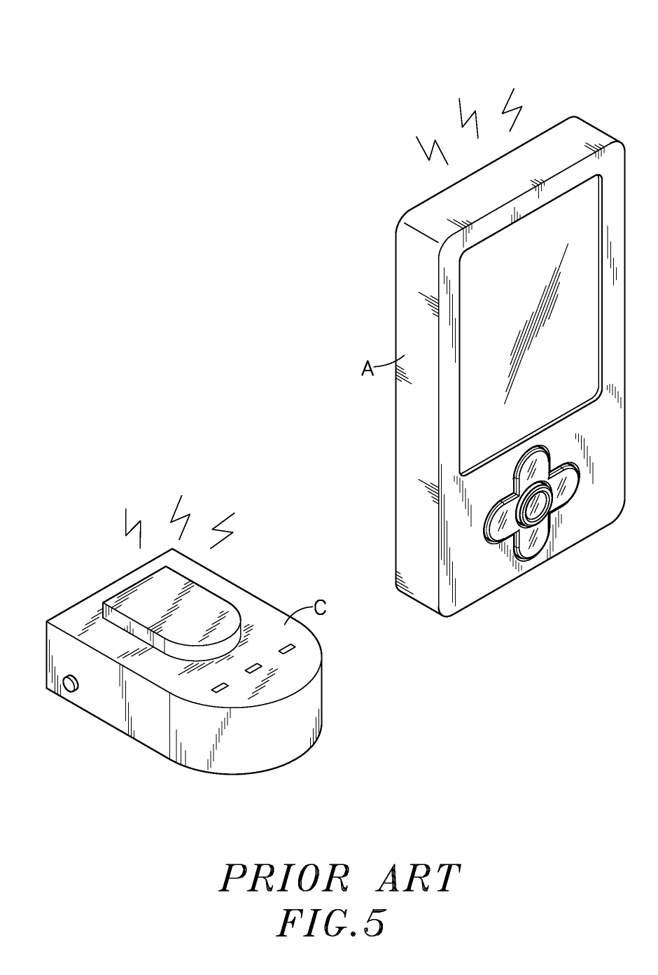

### DETAIL DESCRIPTION OF THE INVENTION

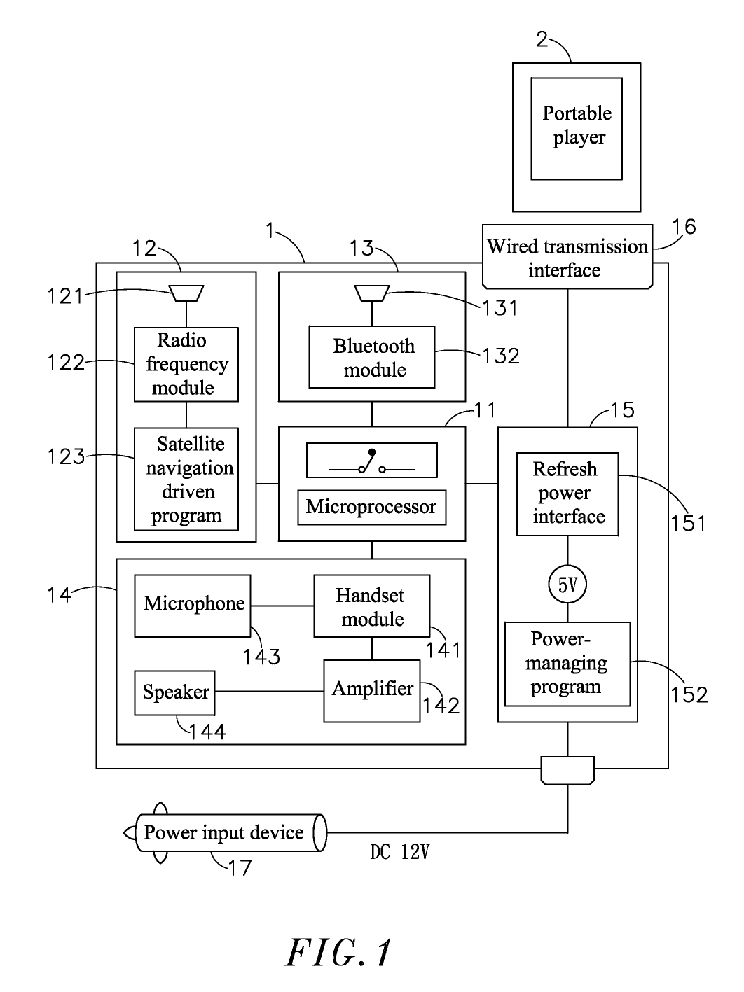

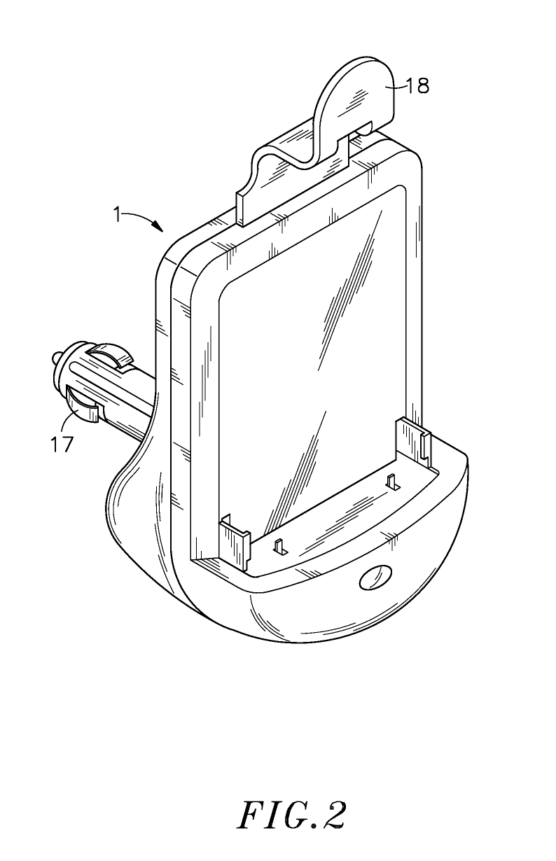

Referring to FIGS. 1 and 2, a satellite navigation conversion device 1 comprises a microprocessor 11, a satellite navigation module 12, a wireless transmission module 13, an audio control module 14, a power control module 15, a wired transmission interface 16, a power input device 17 and a buckling portion 18.

The microprocessor 11 is an integrated circuit interface card for controlling and processing signals received by an internal module in the satellite navigation conversion device 1. The satellite navigation module 12 comprises a positioning signal transceiver 121, a radio frequency module 122 and a satellite navigation driven program 123. The positioning signal transceiver 121 can receives position signals emitted by the GPS, which are calculated by the radio frequency module 122, and then the satellite navigation driven program 123 translates the position signals into signals readable by the microprocessor 11. The wireless transmission module 13 comprises a signal transceiver 131 and a Bluetooth module 132, which is a wireless module capable of transmitting position signals to a portable player 2. The audio control module 14 comprises a handset module 141, an amplifier 142, a microphone 143 and a speaker 144. The audio control module 14 is adopted for playing data transmitted from the microprocessor 11 via the handset module 141, the amplifier 142 and the speaker 144, and the microphone 143 is adopted for inputting sound.

The satellite navigation conversion device 1 can be a mobile phone, a PDA, a mobile phone assistant or any other digital device with a storage device and a screen. The wireless transmission module 13 can be an antenna, a wireless radio, an infrared ray, a Bluetooth or any other wireless transmission interface. It should be noted that the wireless transmission module 13 is merely adopted for transmitting data between the satellite navigation conversion device 1 and the portable player 2, and any equivalent device with the same function for achieving the purpose of the present invention may also be used and shall be construed to be within the scope of the present invention.

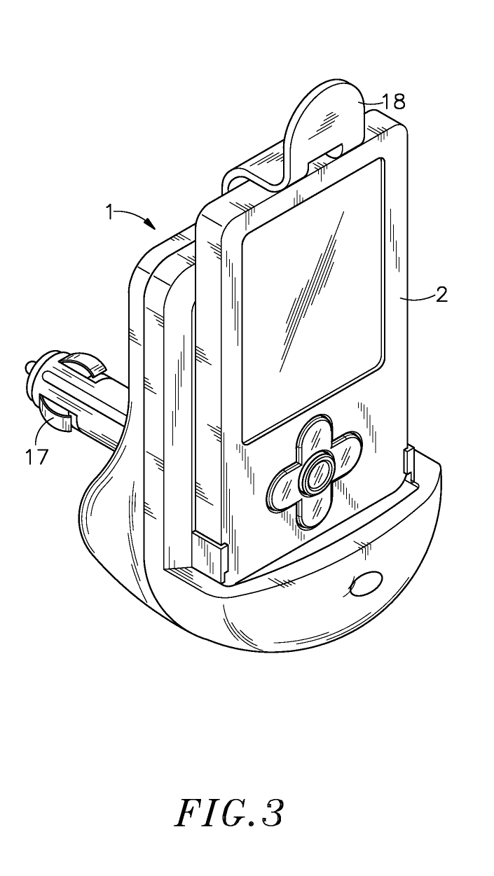

Referring to FIG. 1 again, the power control module 15 comprises a refresh power interface 151 and a power-managing program 152. The power control module 15 supplies power to the satellite navigation conversion device 1 via the power input device 17 and charges to the portable player 2 via the wired transmission interface 16. The power-managing program 152 can convert the power supplied by the power input device 17 into direct current for the satellite navigation conversion device 1 and the portable player 2. Besides, the power-managing program 152 has a power overloading prevention function in order to protect the portable player 2 or the satellite navigation conversion device 1 from being damaged due to short circuit. The power input device 17 can be a cigarette lighter socket, a power socket or any other electrical conducting interface, which serves to transmit power supply between a supply unit and the satellite navigation conversion device 1. Therefore, any other device with the same function shall be construed to be within the scope of the present invention. Furthermore, the wired transmission interface 16 is comprised of a housing adopted for carrying the portable player 2 which can be refreshed via the power control module 15 while the portable player 2 is positioned in the wired transmission interface 16. Referring to FIGS. 2 and 3, the buckling portion 18 of the satellite navigation conversion device 1 can connect the portable player 2 to the satellite navigation conversion device 1.

Referring to FIGS. 1 and 3, when in use, the power input device 17 supplies power to the satellite navigation conversion device 1 and the portable player 2 through the power control module 15, and the satellite navigation module 12 starts to receive position signals via the GPS. The microprocessor 11 transmits the position signals to the portable player 2 via the wireless transmission module 13 or the wired transmission interface 16. The portable player 2 combines the position signals with a map stored therein to calculate the route from the present position to a destination, and a result is displayed on the screen of the portable player 2 for reference. Furthermore, the result may be transmitted from the portable player 2 to the audio control module 14 via the wired transmission module 13 or the wired transmission interface 16 for playing.

Because the satellite navigation module 12 is installed in the satellite navigation conversion device 1, therefore, the satellite navigation conversion device 1 and the portable player 2 share the same power control module 15 and the power input device 17. Accordingly, the satellite navigation conversion device of the present invention has at least the following advantages.

1. The portable player 2 and the satellite navigation conversion device 1 share the same power input device 17, and therefore a user need not worry that the power of the portable player 2 and the satellite navigation conversion device 1 exhaust at the same time. Thus, the user need not refresh the portable player 2 and the satellite navigation conversion device 1 separately.

2. The portable player 2 can be positioned in the wired transmission interface 16 by using the buckling portion 18. Thus, the user need not spend extra money for purchasing a securing element to secure the portable player 2 or the satellite navigation conversion device 1 to a car. The satellite navigation conversion device 1 can be secured to the car by the power input device 17 and the portable player 2 buckles to the satellite navigation conversion device 1 by the buckling portion 18. Thus, the cost can be substantially reduced.

While the invention has been described in conjunction with a specific best mode, it is to be understood that many alternatives, modifications and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A satellite navigation conversion device with a portable player, comprising:
a microprocessor, being an integrated circuit interface card and adopted for controlling and processing signals of an inner module in said satellite navigation conversion device;
a satellite navigation module, connected to a GPS and adopted for receiving and transmitting position signals;
a wired transmission module, being a hardware connector and adopted for receiving/storing data form/to said portable player;
a power control module, adopted for converting power supply into direct current suitable for said satellite navigation conversion device and said portable player; and
a power input device, adopted for receiving power from external power devices.

2. The satellite navigation conversion device according to claim 1, wherein said portable player can be a cellular phone, a PDA or a mobile telephone assistant.

3. The satellite navigation conversion device according to claim 1, wherein said microprocessor transmits said position signals received by said satellite navigation module to said portable player via said wired transmission interface or a wireless transmission module.

4. The satellite navigation conversion device according to claim 1, wherein said satellite navigation module comprises a positioning signal transceiver, a radio frequency module and a satellite navigation driven program, wherein said satellite navigation module can receive said position signals and transmit to said microprocessor.

5. The satellite navigation conversion device according to claim 3, wherein said wireless transmission module comprises a signal transceiver and a wireless module, wherein said wireless transmission module can transmit or receives signals to said portable player or said microprocessor, and said wireless transmission module can be an antenna, a radio, an infrared ray or a Bluetooth.

6. The satellite navigation conversion device according to claim 1, wherein said satellite navigation conversion device comprises an audio control module having an audio input device and an output device.

7. The satellite navigation conversion device according to claim 6, wherein said audio input device can be a microphone and said audio output device can be a speaker.

8. The satellite navigation conversion device according to claim 1, wherein said power control module comprises a refresh power interface for supplying power or refreshing to said portable player via said wired transmission interface.

9. The satellite navigation conversion device according to claim 1, wherein said power control module comprises a power-managing program having a power overload prevention function in order to protect said portable player or said satellite navigation conversion device from being damaged due to short circuit.

10. The satellite navigation conversion device according to claim 1, wherein said wired transmission interface comprises a housing for carrying said portable player.

11. The satellite navigation conversion device according to claim 1, wherein said satellite navigation conversion device comprises a buckling portion for buckling said portable player to said satellite navigation conversion device.

12. The satellite navigation conversion device according to claim 1, wherein said power input device can be a cigarette lighter socket or a power socket for transmitting power supply between said satellite navigation conversion device and said external power device.
